(19) United States
(12) Patent Application Publication
(10) Pub. No.: US 2007/0109815 A1
(43) Pub. Date: May 17, 2007

(54) Decorative light

(76) Inventor: Wei-Jen Tseng, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/274,175

(22) Filed: Nov. 16, 2005

(51) Int. Cl. H01R 33/00

(52) U.S. Cl. 362/647

(57) ABSTRACT

A decorative light has a socket, two prongs, a light bulb holder and a light bulb. The socket has a top, a through hole and a seat. The seat is formed coaxially with the through hole and has a diameter and a depth. The prongs are mounted in and protrude from the through hole. The light bulb holder is mounted in the seat and has a body, a flange and a plug. The body has a length corresponding to the depth of the seat. The flange is formed around and protrudes out from the light bulb holder and abuts the top of the socket. The plug is mounted in the through hole, is formed on and protrudes coaxially from the bottom the body and has a distal end and a length. The distal end abuts the prongs. The light bulb has two wires.

### BACKGROUND OF THE INVENTION

1. Field of the Invention

The present invention relates to a decorative light, and more particularly to a decorative light with an error-proof mounting assembly to keep from installing a light bulb holder in an incorrect socket.

2. Description of Related Art

Conventional strings of decorative lights, such as strings of Christmas lights, may have many different types of decorative lights to create a variety of beautiful light effects. However, mounting different types of decorative lights on a single string requires some technique to ensure light bulb holders are not mounted in incorrect sockets.

To overcome the shortcomings, the present invention provides a decorative light to mitigate or obviate the aforementioned problems.

### SUMMARY OF THE INVENTION

The main objective of the invention is to provide a decorative light to keep from installing a light bulb holder in an incorrect socket.

A decorative light in accordance with the present invention comprises a socket, two prongs, a light bulb holder, a light bulb and an error-proof mounting assembly.

The socket has a top, a bottom, a through hole and a seat. The through hole is formed coaxially through the bottom of the socket and has a diameter. The seat is formed coaxially with the through hole in the top of the socket and has a diameter and a depth. The diameter of the seat is slightly larger than the diameter of the through hole.

The prongs are mounted in the through hole and protrude from the bottom of the socket. The prongs are mounted specific distances in the through hole.

The light bulb holder is mounted removably in the seat and the through hole in the socket, abuts the top of the socket and has a body, a flange and a plug. The body is mounted in the seat and has a bottom and a length corresponding to the depth of the seat. The flange is formed around and protrudes out from the top of the light bulb holder and abuts the top of the socket. The plug is mounted in the through hole, is formed on and protrudes coaxially from the bottom of the body and has a distal end and a length.

The light bulb is mounted in the light bulb holder and has two wires. The wires are mounted in and extend through the plug and are in electrical contact respectively with the two prongs.

The error-proof mounting assembly is provided between the light bulb holder and the socket to keep a light bulb mounted in a light bulb holder from being mounted in an incorrect socket.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a decorative light in accordance with the present invention;

FIG. 2 is a front view in partial section of the decorative light in FIG. 1;

FIG. 3 is a perspective view of a second embodiment of a decorative light in accordance with the present invention with a long plug;

FIG. 4 is a front view in partial section of the decorative light in FIG. 3;

FIG. 5 is a front view in partial section of mounting a light bulb holder in FIG. 2 in a socket in FIG. 1;

FIG. 6 is a front view in partial section of mounting a light bulb holder in FIG. 1 in the socket in FIG. 2;

FIG. 7 is a perspective view of a third embodiment of a decorative light in accordance with the present invention with a long body;

FIG. 8 is a front view in partial section of the decorative light in FIG. 7;

FIG. 9 is a front view in partial section of mounting a light bulb holder in FIG. 7 in a socket in FIG. 1;

FIG. 10 is a front view in partial section of mounting a light bulb holder in FIG. 1 in a socket in FIG. 7;

FIG. 11 is a perspective view of a fourth embodiment of a decorative light in accordance with the present invention with a keyed seat and body and an asymmetric plug;

FIG. 12 is a front view in partial section of the decorative light in FIG. 11;

FIG. 13 is a perspective view of a fifth embodiment of a decorative light in accordance with the present invention with a keyed seat and body and an asymmetric plug;

FIG. 14 is a front view in partial section of the decorative light in FIG. 13;

FIG. 15 is a front view in partial section of mounting a light bulb holder in FIG. 13 in a socket in FIG. 11;

FIG. 16 is a front view in partial section of mounting a light bulb holder in FIG. 11 in a socket in FIG. 13;

FIG. 17 is a perspective view of a sixth embodiment of a decorative light in accordance with the present invention with a keyed seat, body and plug; and

FIG. 18 is a front view in partial section of the decorative light in FIG. 17.

### DETAILED DESCRIPTION OF PREFERRED EMBODIMENT

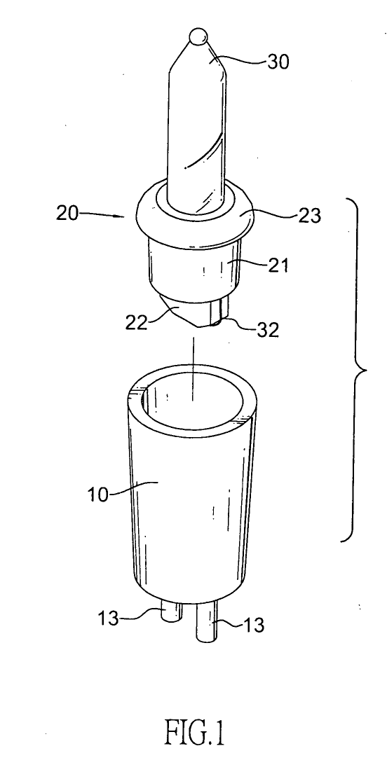

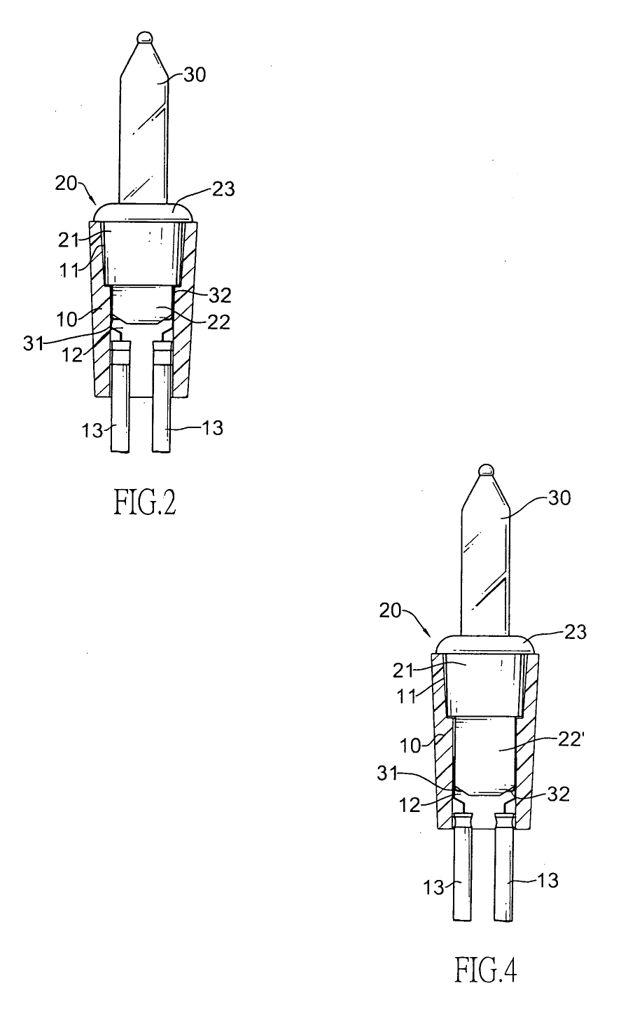

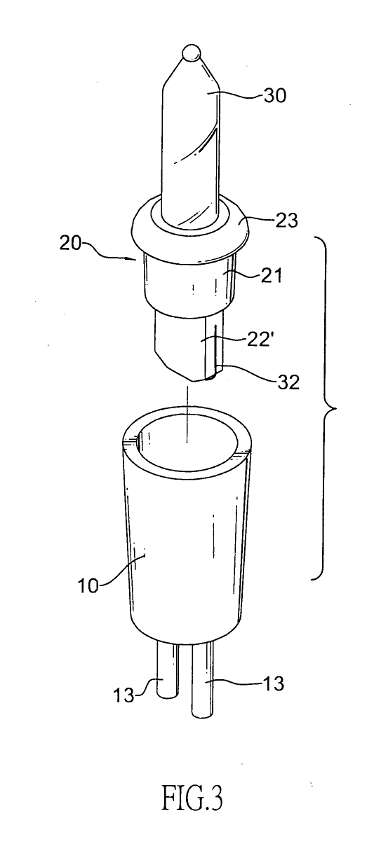

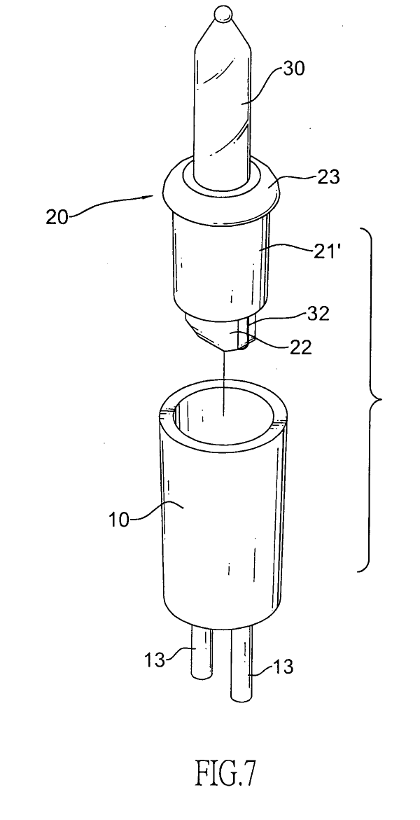

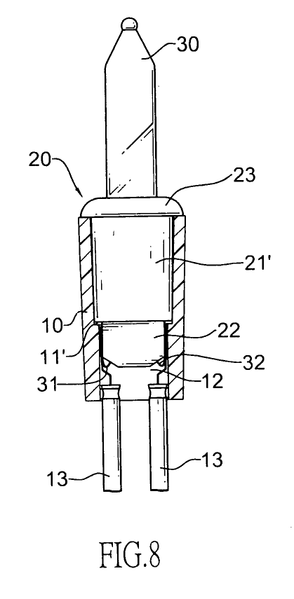

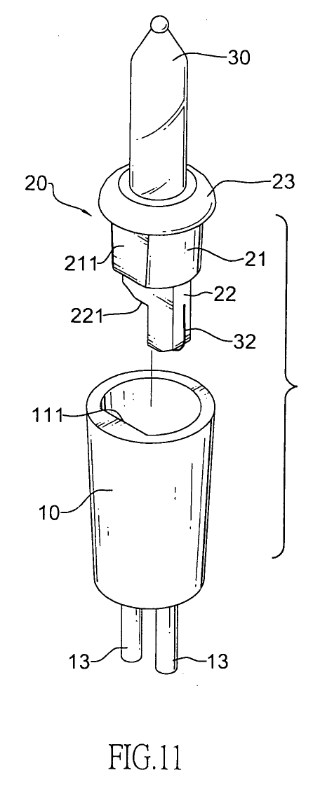

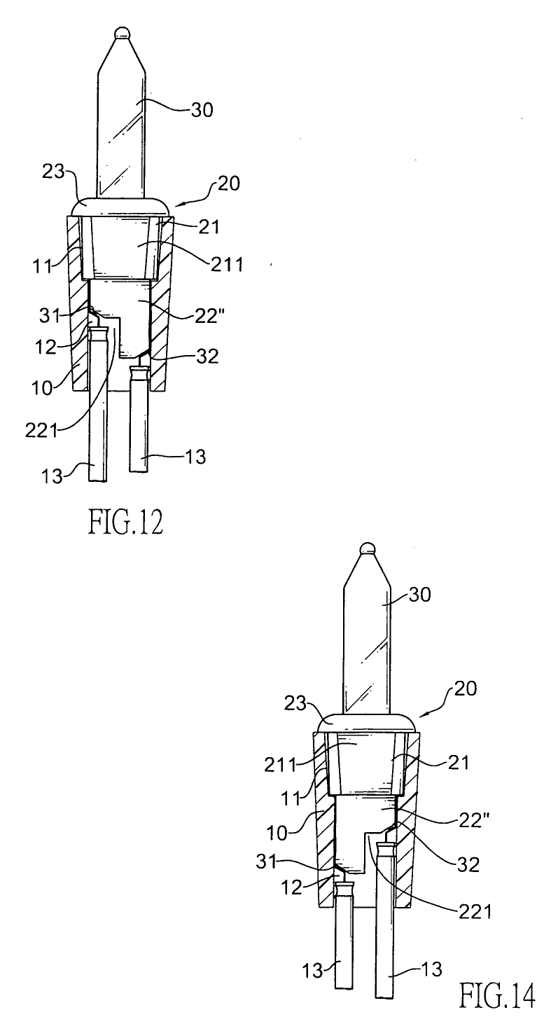

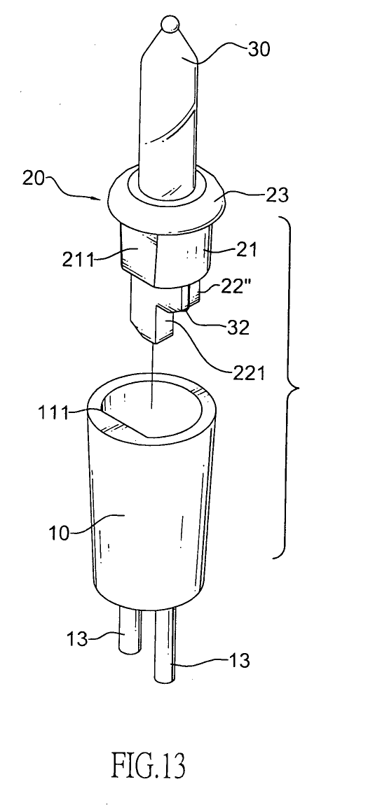

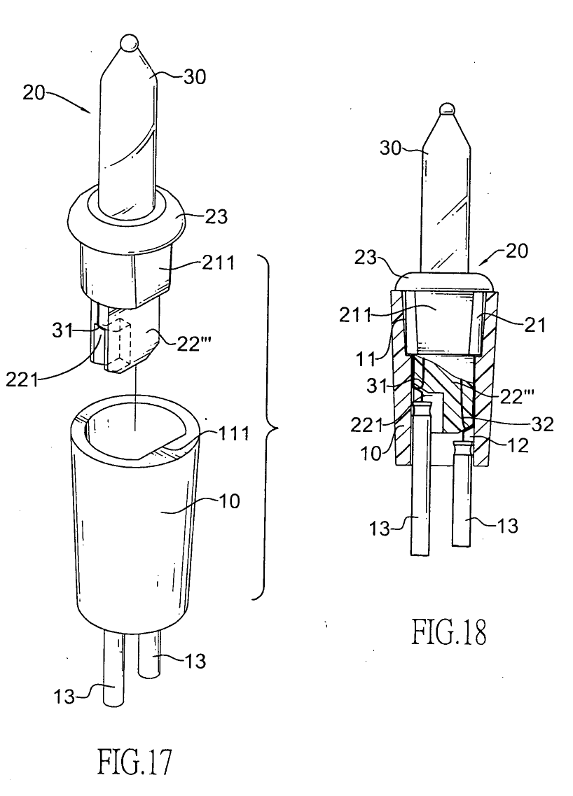

With reference to FIGS. 1-4, 7, 8, 11-14, 17 and 18, a decorative light in accordance with the present invention comprises a socket (10), two prongs (13), a light bulb holder (20), a light bulb (30) and an error-proof mounting assembly.

The socket (10) may be a cylinder and has a top, a bottom, a through hole (12) and a seat (11, 11′).

The through hole (12) is formed coaxially through the bottom of the socket (10) and has a diameter.

The seat (11, 11′) is formed coaxially with the through hole (12) in the top of the socket (10), may be slightly tapered from the top of the socket (10) toward the bottom and has a diameter, a depth, a sidewall and an optional key surface (111). The diameter of the seat (11, 11′) is slightly larger than the diameter of the through hole (12). The depth of the seat (11, 11′) may be deep or shallow to accommodate different embodiments of the decorative light. Furthermore, the key surface (111) is formed on the sidewall.

The prongs (13) are mounted in the through hole (12) in the socket (10), extend into the through hole (12) and protrude from the bottom of the socket (10) to connect to an external power source, and each prong (13) has a proximal end and a length. The proximal end of each prong (13) extends into the through hole (12) in the socket (10) a specific distance. The distances of the proximal ends of the two prongs (13) extending into the through hole (12) in the socket (10) in different embodiments of the decorative light may be the same, may be different, may be shallow or may be deep.

The light bulb holder (20) is mounted removably in the seat (11, 11′) and the through hole (12) in the socket (10), abuts the top of the socket (10) and has a body (21, 21′), a flange (23) and a plug (22, 22′, 22″).

The body (21, 21′) is mounted removably in the seat (11, 11′) and has a top, a bottom, a bulb socket, a sidewall and a length. The bulb socket is formed coaxially in the top of the body (21, 21′). The sidewall is formed around the body (21, 21′) from the top to the bottom and has an optional key surface (211). The key surface (211) on the sidewall of the body (21) corresponds to and abuts the key surface (111) on the sidewall of the seat (11) to force the light bulb holder (20) to be mounted correctly in the socket (10). The length of the body (21, 21′) corresponds to the depth of the seat (11, 11′) when the light bulb holder (20) is mounted in the socket (10).

The flange (23) is formed around and protrudes out from the top of the body (21, 21′) and abuts the top of the socket (10) when the light bulb holder (20) is mounted in the socket (10).

The plug (22, 22′, 22″) is mounted removably in the through hole (12), is formed coaxially on and protrudes from the bottom of the body (21, 21′), may be symmetrical or asymmetrical and has a distal end, a length and an optional notch (221). The distal end of the plug (22, 22′, 22″) corresponds to the proximal ends of the prongs (13) and abuts the prongs (13) when the body (21, 21′) is seated in the seat (11, 11′). The length of the plug (22, 22′, 22″) corresponds to the distances of the proximal ends of the two prongs (13) extending into the through hole (12) in the socket (10). The notch (221) in the distal end of the plug (22″, 22′″) may be a cutout or a longitudinal slot and accommodates one prong (13) extending farther into the through hole (12) in the socket (10) than the other prong (13) to ensure that the light bulb holder (20) is mounted correctly in the socket (10).

The light bulb (30) is mounted removably in and protrudes from the bulb socket in the body (21, 21′) of the light bulb holder (20) and has two wires (31, 32).

The wires (31, 32) protrude from the light bulb (30), pass respectively through the bulb socket of the body (21, 21′), extend down the plug (22, 22′) to the distal end and make electrical contact respectively with the two prongs (13).

The error-proof mounting assembly is mounted between the socket (10) and the light bulb holder (20). In preferred embodiments, the error-proof mounting assembly is provided between the seat (11, 11′) and the body (21, 21′) or between the distances of the proximal ends of the prongs (13) extending into the through hole (12) in the socket (10) and the plug (22, 22′) to keep a light bulb (30) mounted in a specific light bulb holder (20) from being mounted in an incorrect socket (10).

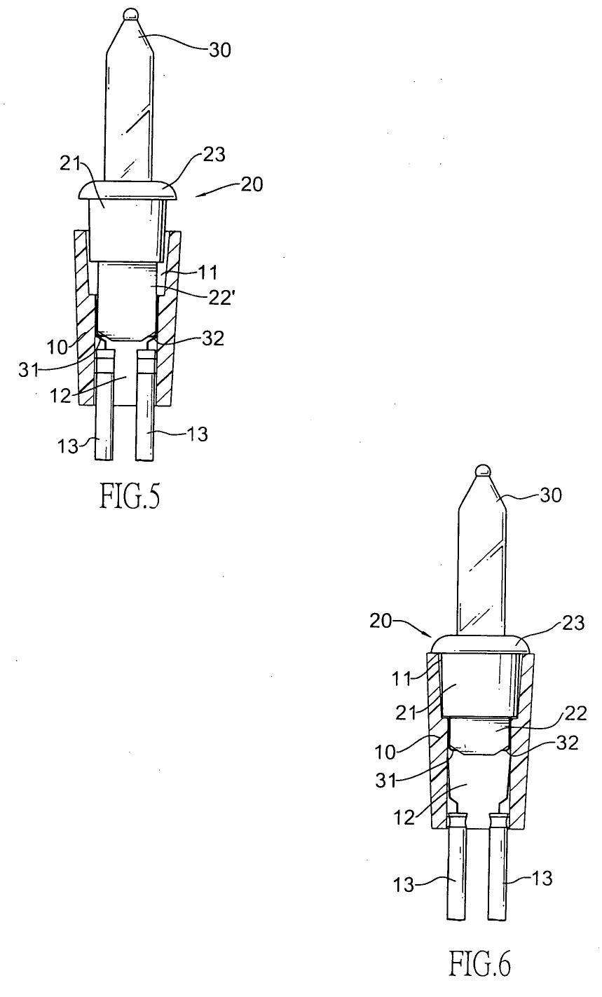

The error-proof mounting assembly can be provided by the length of the plug (22, 22′) corresponding to the distances of the proximal ends of the prongs (13) extending into the through hole (12) in the socket (10). Referring to FIG. 5, the light bulb holder (20) with the plug (22′) having a long length cannot be mounted suitably in the socket (10) with deep distances of the proximal ends of the prongs (13) extending into the through hole (12) in the socket (10). With reference to FIG. 6, the distal end of the plug (22) having a short length cannot contact the prongs (13) having shallow distances of the proximal ends extending into the through hole (12), so that the wires (31, 32) can not be in electrical contact respectively with the two prongs (13).

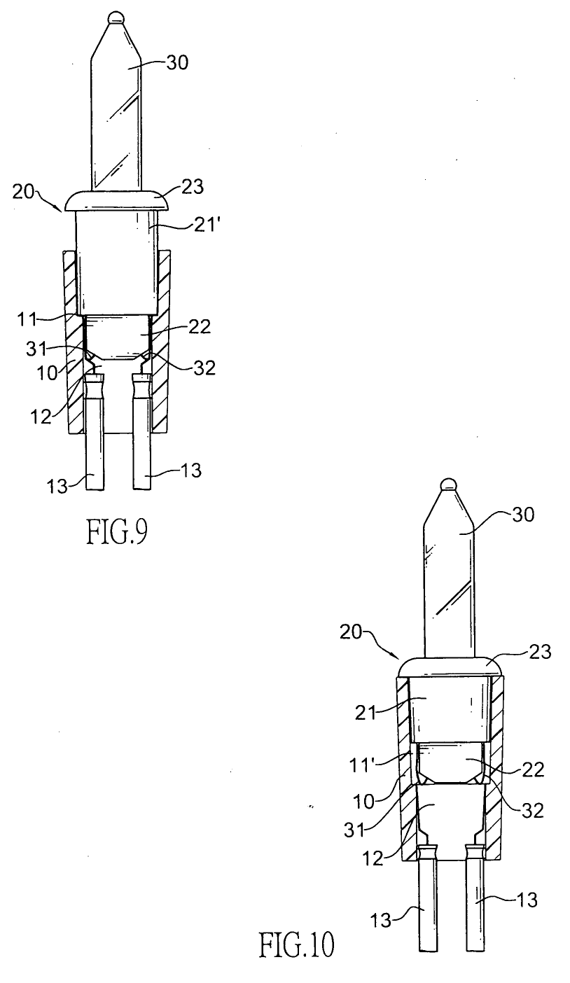

The error-proof mounting assembly can be provided by the length of the body (21, 21′) corresponding to the depth of the seat (11, 11′). Referring to FIG. 9, the light bulb holder (20) with the body (21′) having a long length cannot be mounted suitably in the socket (10) with a shallow depth of the seat (11). With reference to FIG. 10, the body (21) having a short length causes that the distal end of the plug (22) cannot contact the prongs (13) in the socket (10) so the wires (31, 32) can not be in electrical contact respectively with the two prongs (13).

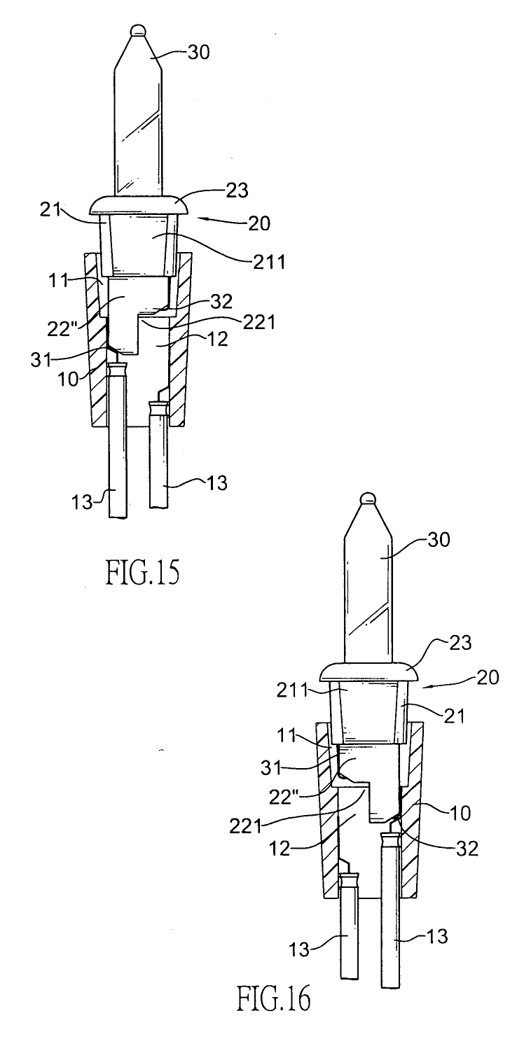

The error-proof mounting assembly can be provided by one of the proximal end of the prong (13) abutting the plug in the notch (221) and the other of the proximal end of the prong (13) abutting the distal end of the plug. Referring to FIGS. 15 and 16, the light bulb holder (20) with the notch (221) in the distal end of the plug (22″) cannot be mounted suitably in the socket (10) with the proximal ends of the prongs (13) opposing to the notch (221) in the distal end of the plug (22″) when the light bulb holder (20) is inserted into the socket (10) in a wrong direction.

The configuration of the body (21, 21′) and the seat (11, 11′) and the plug (22, 22′) and the prongs (13) provide an error-proof mounting effect for a decorative light that keeps a light bulb (30) mounted in a specific light bulb holder (20) from being mounted in an incorrect socket (10).

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A decorative light comprising:
a socket having
a top;
a bottom;
a through segment formed coaxially through the bottom of the socket and having a diameter;
a seat formed coaxially with the through hole in the top of the socket and having
a diameter being slightly larger than the diameter of the through hole;
a depth; and
a sidewall;
two prongs mounted in the through hole in the socket, extending into the through hole and protruding from the bottom of the socket, and each prong having
a proximal end extending into the through hole in the socket a specific distance; and
a length;
a light bulb holder mounted removably in the seat and the through hole in the socket, abutting the top of the socket and having
a body mounted movably in the seat and having
a top;
a bottom;
a bulb socket formed coaxially in the top of the body;
a sidewall formed around the body from the top to the bottom; and
a length corresponding to the depth of the seat when the light bulb holder is mounted in the socket;
a flange formed around and protruding out from the top of the body and abutting the top of the socket when the light bulb holder is mounted in the socket; and
a plug mounted removably in the through hole, formed coaxially on and protruding from the bottom of the body and having
a distal end corresponding to the proximal ends of the prongs and abutting the prongs when the body is seated in the seat; and
a length corresponding to the distances the proximal ends of the two prongs extending into the through hole in the socket;
a light bulb mounted removably in and protruding from the bulb socket in the body of the light bulb holder and having two wires protruding from the light bulb, passing respectively through the bulb socket of the body, extending down the plug to the distal end and making electrical contact respectively with the two prongs; and
an error-proof mounting assembly provided between the light bulb holder and the socket to keep a light bulb mounted in a light bulb holder from being mounted in an incorrect socket.

2. The decorative light as claimed in claim 1, wherein the error-proof mounting assembly is provided by the length of the plug corresponding to the distances of the proximal ends of the prongs extending into the through hole in the socket.

3. The decorative light as claimed in claim 1, wherein the error-proof mounting assembly is provided by the length of the body corresponding to the depth of the seat.

4. The decorative light as claimed in claim 1, wherein
the seat further has a key surface formed on the sidewall; and
the sidewall of the body of the light bulb holder further has a key surface corresponding to and abutting the key surface on the sidewall of the seat.

5. The decorative light as claimed in claim 4, wherein
the plug is asymmetrical and has a notch formed in the distal end;
one of the prongs is mounted a distance into the through hole so the proximal end of the prong abuts the plug in the notch when the light bulb holder is seated in the socket; and
the other prong is mounted a different distance into the through hole so the proximal end of the prong abuts the distal end of the plug when the light bulb holder is seated in the socket.

6. The decorative light as claimed in claim 5, wherein the error-proof mounting assembly is provided by one of the proximal end of the prong abutting the plug in the notch and the other of the proximal end of the prong abutting the distal end of the plug.
the notch of the plug corresponding to the distance each proximal end of the prongs extending into the through hole in the socket.

7. The decorative light as claimed in claim 1, wherein the socket is a cylinder.

8. The decorative light as claimed in claim 1, wherein the seat is slightly tapered from the top of the socket toward the bottom.

9. The decorative light as claimed in claim 5, wherein the notch in the distal end of the plug is a cutout.

10. The decorative light as claimed in claim 5, wherein the notch in the distal end of the plug is a longitudinal slot.
